(19) United States
(12) Patent Application Publication
(10) Pub. No.: US 2003/0183656 A1
(43) Pub. Date: Oct. 2, 2003

(54) Perforated ice bin insert

(75) Inventor: Joseph D. Siefker, Grafton, OH (US)

Correspondence Address: John P. Cornely, Fay, Sharpe, Fagan, Minnich & McKee, LLP, 7th Floor, 1100 Superior Avenue, Cleveland, OH, 44114-2518, US

(73) Assignee: Cold Core, Ltd.

(21) Appl. No.: 10/401,298

(22) Filed: Mar. 27, 2003

Related U.S. Application Data
(60) Provisional application No. 60/368,194, filed on Mar. 27, 2002.

(51) Int. Cl. G01F 11/06; G01F 11/30; G01F 11/36; G01F 11/42; B65D 88/54; F25C 5/18

(52) U.S. Cl. 222/329; 62/344

(57) ABSTRACT

An ice bin insert (10) separates a single store of ice pieces into separate stashes, namely, into potable and non-potable portions. The insert (10) includes a divider (C, D) dimension to be received within an ice holding cavity of an ice bin (30). Support members (B, E) attached to the divider (C, D) hold the divider (C, D) at a desired position within the ice holding cavity of the ice bin (30). A plurality of perforations (12) are arranged within the divider (C, D) so as to permits ice pieces to flow from a first side thereof to a second side thereof while inhibiting retrieval of ice pieces on the second side from the first side. Preferably, the insert (10) is constructed from a unitary sheet of stainless steel which is bent to define the respective portions or sections thereof.

This application claims the benefit of U.S. Provisional Application No. 60/368,194, filed Mar. 27, 2002, incorporated herein by reference in its entirety.

### FIELD

The present invention relates to beverage cooling arts. It finds particular application in conjunction with commercial-type open system ice bins and open system loose auxiliary beverage cooling plates or like devices, and will be described with particular reference thereto. However, it is to be appreciated that the present invention is also amenable to other like applications.

### BACKGROUND

Commercially, some vendors employ open ice bin systems for the cooling of beverages (i.e., soft drinks and the like). Often, beverage cooling in such an environment is accomplished by placing a separate loose auxiliary cooling device in an open ice bin and covering it with otherwise potable ice. This can result in the contamination of the potable ice from contact with the auxiliary cooling device and its supporting connections. Consequently, the otherwise potable ice may be changed into “non-potable ice” in accordance with some health codes and deemed not fit for human consumption. This can be disadvantageous insomuch as commercial beverage vendors would like to manually serve ice to their customers out of the same open ice bin. In other words, the current practice of placing the separate loose auxiliary cooling device inside an open ice bin with sufficient ice storage capacity to provide cooling to the auxiliary cooling device and storage for potable ice can be disadvantageous to the extent that it renders the otherwise potable ice unfit for human consumption because ice in direct contact with the auxiliary cooling device and/or supporting connections is considered contaminated by some health code standards.

One option is to have separate distinct open ice bins for the potable ice and the auxiliary cooling device. This is often times inefficient and burdensome on the vendor insomuch as it would mean that the vendor is purchasing and/or maintaining separate dedicated pieces of equipment, presuming space for the same is even available.

Smaller ice pans are sometimes filled with the potable ice and placed in the open ice bin. The customers are served ice out of this smaller ice pan. The rest of the open ice bin, containing the auxiliary cooling device, can then be filled with non-potable ice. This technique essentially divides the ice bin into two distinct ice storage areas, i.e., inside the pan and outside the pan. Accordingly, the potable ice inside the pan remains separate and distinct from the non-potable ice outside the pan, which is in direct contact with the auxiliary cooling device. However, oftentimes, the space restraints of the ice bin do not allow the smaller ice pans to be inserted therein. Further, even if the smaller ice pan does fit, the vendor is still burdened with having to maintain two distinct stores of ice with reduced capacity, which in turn is burdensome to the vendor.

Another solution is to use a cooling device which is sealed from or otherwise outside the ice receiving cavity of the ice bin. However, such a solution does not easily or readily retrofit with respect to existing equipment or open ice bins. Accordingly, use of sealed cooling devices commonly involves the purchase of all new equipment, which can be financially burdensome and foregoes the opportunity to take advantage of existing open system equipment. Sealed cooling devices also tend to be more difficult to service insomuch as they are sealed and often integrated with the ice bin, hence they are typically less accessible than separate loose auxiliary cooling devices. For example, such an ice bin unit with the cooling device sealed in below the surface of the interior ice storage cavity can be costly, and the auxiliary cooling devices may not be readily accessible for cleaning, inspection and/or servicing purposes.

The present invention contemplates a new and improved perforated ice bin insert, which maintains a manual, open system operation utilizing existing open system equipment and overcomes the above-referenced problems and others.

### SUMMARY

In accordance with one aspect of the present invention, an ice bin insert is provided for a manual service open ice bin having an ice holding cavity. The insert separates a single store of ice pieces into separate stashes and includes a divider dimension to be received within the ice holding cavity of the ice bin, and support members attached to the divider. The support members hold the divider at a desired position within the ice holding cavity of the ice bin. A plurality of perforations are formed in the divider. The perforations are arranged such that the divider permits ice pieces to flow from a first side thereof to a second side thereof while inhibiting retrieval of ice pieces on the second side from the first side.

In accordance with a more limited aspect of the present invention, the divider and said support members are formed from a substantially rigid material, the support members including at least one wall having a shape which substantially conforms to a contour of an ice bin wall that defines the ice holding cavity of the ice bin.

In accordance with a more limited aspect of the present invention, the divider and support members are formed from a substantially planar unitary sheet of material having a plurality of bends therein which define the divider and support members.

In accordance with a more limited aspect of the present invention, the divider includes a substantially planar first section.

In accordance with a more limited aspect of the present invention, the support members are arranged to hold the divider at a height above a floor of the ice holding cavity of the ice bin. The height is sufficient to permit an auxiliary cooling device and a layer of ice pieces surrounding the same to be arranged between the divider and the floor of the ice holding cavity of the ice bin.

In accordance with a more limited aspect of the present invention, the support members are arranged to hold the first section substantially parallel to the floor of the ice holding cavity of the ice bin.

In accordance with a more limited aspect of the present invention, the divider includes a substantially planar second section arranged between the first section and at least one of the support members, the second section being sloped relative to the first section.

In accordance with a more limited aspect of the present invention, the support members includes substantially planar first and second walls connected to the divider, each of the first and second walls being connected to respective opposing ends of the divider.

In accordance with a more limited aspect of the present invention, the walls are substantially normal to the first section of the divider.

In accordance with a more limited aspect of the present invention, the walls do not permit ice pieces to flow therethrough.

In accordance with a more limited aspect of the present invention, the ice bin insert further includes a channel formed at an end of the first wall opposite the divider. The channel is arranged to receive therein a lip of the ice bin, the lip defining at least a portion of an opening for the ice holding cavity of the ice bin.

In accordance with a more limited aspect of the present invention, the ice bin insert further includes a substantially planar connecting plate formed at an end of the second wall opposite the divider, the connecting plate being arranged for engagement with at least a portion of the ice bin so that the insert is supported therefrom.

In accordance with a more limited aspect of the present invention, the connecting plate is substantially normal to the second wall and arranged so as to rest upon a portion of the ice bin.

In accordance with a more limited aspect of the present invention, the connecting plate includes at least one opening therein for passing through connections to an auxiliary cooling device situated under the insert in the ice holding cavity of the ice bin.

In accordance with a more limited aspect of the present invention, the connecting plate includes holes therein through which fasteners pass to fasten the insert to the ice bin.

In accordance with another aspect of the present invention, an insert for an ice bin includes a vertically extending first wall, the first wall being solid and having opposing first and second ends; a vertically extending second wall, the second wall being solid and having opposing first and second ends; and, a horizontally extending perforated first plate connected between the first ends of the first and second walls. The insert is arranged so as to permit ice pieces to migrate through the first plate and restrict access to ice pieces once they have migrated through the first plate.

In accordance with a more limited aspect of the present invention, the insert includes a perforated second plate connected between the first plate and the second wall, the second plate being sloped with respect to the first plate and permitting ice pieces to migrate therethrough.

In accordance with a more limited aspect of the present invention, the insert includes a channel formed at the second end of the first wall, the channel arranged to receive at least a portion of a lip of an ice bin such that the insert is supported thereon.

In accordance with a more limited aspect of the present invention, the insert includes a connection plate formed at the second end of the second wall, the connection plate arranged to engage with at least a portion of an ice bin such that the insert is supported thereby.

In accordance with a more limited aspect of the present invention, the first and second walls and the first and second plates are formed from a unitary sheet of stainless steel.

In accordance with a more limited aspect of the present invention, a portion of the insert rests upon a portion of the ice bin without being attached thereto such that the insert is supported by the ice bin and selectively removable from and installable in the ice bin, the first plate being positioned inside an ice holding cavity of the ice bin above a floor of the ice holding cavity when the insert is installed in the ice bin.

In accordance with yet another aspect of the present invention, a beverage cooling system includes: an ice bin having an ice holding cavity including a floor and one or more walls defining the cavity and an opening through which ice pieces are selective loaded into and removed from the cavity; a loose auxiliary cooling device separate from the ice bin and placed on the floor inside the cavity of the ice bin; one or more supporting connections operatively connected with the cooling device to circulate a beverage to be cooled through the cooling device; a divider arranged within the ice holding cavity of the ice bin; support members attached to the divider, the support members holding the divider at a desired position above the cooling device within the ice holding cavity of the ice bin; and, a plurality of perforations within the divider, the perforations being arranged such that the divider permits ice pieces to flow from a top side of the divider to a bottom side of the divider while inhibiting retrieval of ice pieces on the bottom side from the top side.

In accordance with a more limited aspect of the present invention, the divider and support members comprise an insert which is selectively removable from the ice bin.

In accordance with a more limited aspect of the present invention, the insert includes cutouts through which the supporting connections are routed when the insert is installed in the ice bin.

In accordance with a more limited aspect of the present invention, the insert extends through the opening of the ice bin when installed therein.

One advantage of the present invention is that it optionally provides the ability to segregate a single store of ice into potable and non-potable portions.

Another advantage of the present invention is that it optionally provides the ability to use a single ice bin unit for both the cooling of auxiliary cooling devices and the storage of ice for consumption.

Yet another advantage of the present invention is that it optionally provides an economically attractive retrofit for existing manual service open ice bin units.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention. Further, it is to be appreciated that the drawings are not to scale.

FIG. 1 is a diagrammatic illustration showing a perspective view of an exemplary embodiment of a perforated ice bin insert in accordance with aspects of the present invention.

FIG. 2 is a diagrammatic illustration showing a sectional view of the ice bin insert of FIG. 1 taken along section line 2-2.

FIG. 3 is a diagrammatic illustration showing the perforated ice bin insert of FIG. 1 in an exemplary use in an open ice bin.

FIG. 4 is a diagrammatic illustration showing a perspective view of another exemplary embodiment of a perforated ice bin insert in accordance with aspects of the present invention.

FIG. 5 is a diagrammatic illustration showing a sectional view of the ice bin insert of FIG. 4 taken along section line 5-5.

### DETAILED DESCRIPTION OF PREFERRED EMBODIMENTS

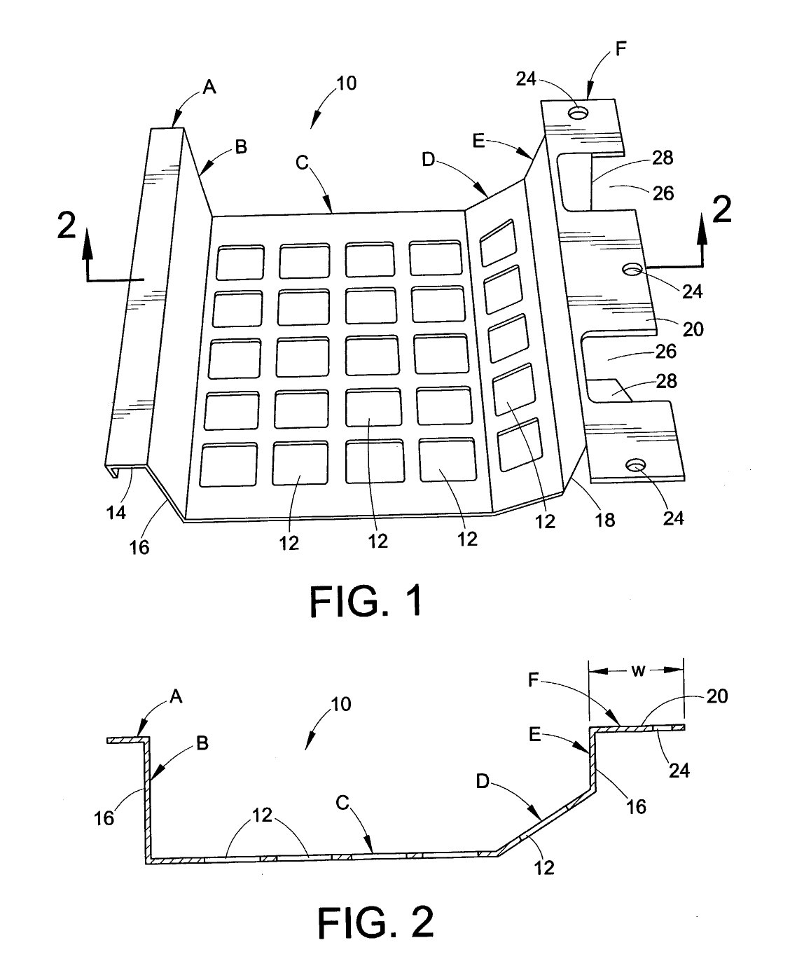

With reference to FIGS. 1 and 2, an exemplary embodiment of a perforated ice bin insert 10 in accordance with aspects of the present invention is preferably made out of 304 stainless steel. However, other suitable materials may be used, e.g., other suitable materials preferably are substantially rigid, durable, corrosion resistant and/or non-porous materials which meet or exceed health and safety code specifications for the food and beverage service/preparation industries. In a preferred embodiment, the insert 10 meets or exceeds the National Sanitation Foundation (NSF) guidelines and/or American National Standards Institute (ANSI) standards for the food and beverage service/preparation industries. The insert 10 is preferably of one-piece construction, i.e., a single sheet or plate of material formed with or otherwise made to have multiple perforations 12 and bends. The insert 10 may be dimensioned as desired to fit into various sizes of open ice bins. That is to say, the insert's length, width and/or depth may vary so as to closely match interior dimensions of various manual service open ice bins, i.e., ice bins of the type where a vendor exercises direct access to the ice therein for manual serving of the same.

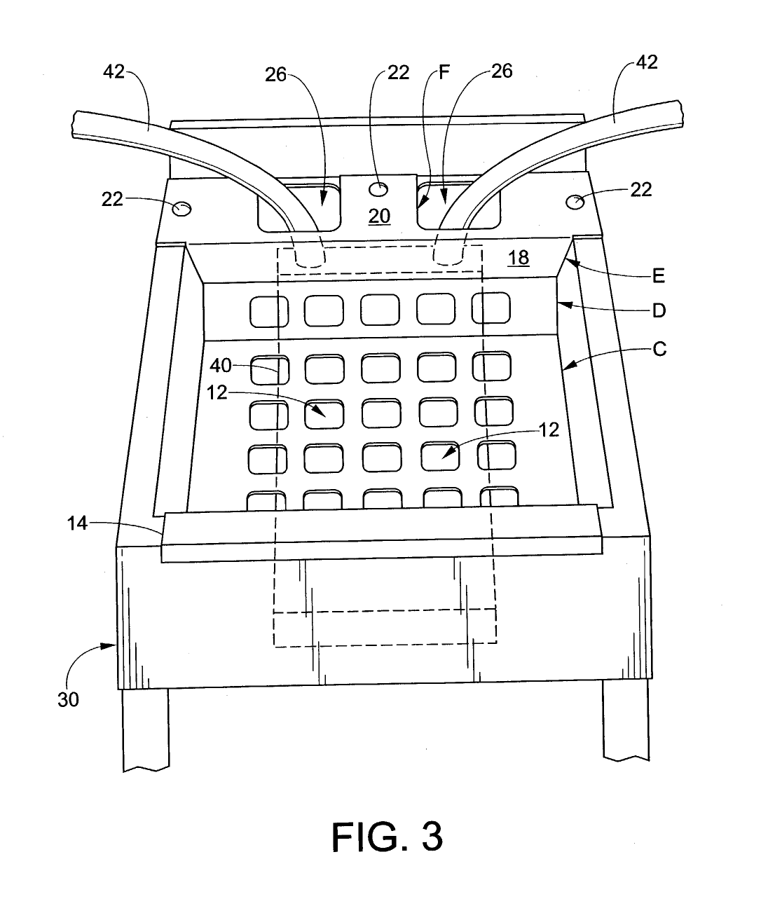

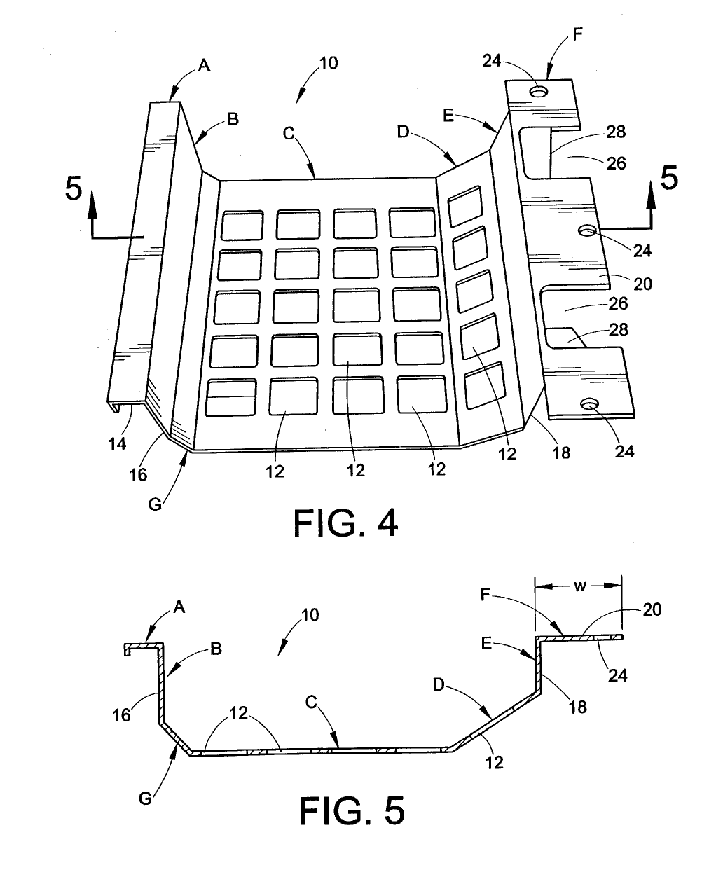

Preferably, when installed in an ice bin, such as the manual service open ice bin unit 30 as shown in FIG. 3, at least a portion of a periphery of the insert 10 is attached to and/or rests upon at least a portion of a periphery of the ice bin opening. Alternately, the insert 10 may otherwise be supported in and/or attached to the ice bin 30. For example, the insert 10 may rest on the bottom floor of the ice bin's storage area, and include legs or other supports that raise the perforated section of the insert 10 above the same.

Referring again to FIGS. 1 and 2, via the aforementioned bends or otherwise, the insert 10 is preferably formed so that it extends through the opening into an ice storage or holding cavity of the manual service open ice bin unit 30. In the illustrated embodiment, the insert 10 possesses six primary sections defined by the aforementioned bends. The sections include: a front mounting section A, a front wall section B, first and second floor sections C and D, a rear wall section E, and a rear mounting section F.

As shown, the front mounting section A includes an inverted j-channel 14 arranged to conform to and receive a front lip of the ice bin unit 30 when installed therein (see FIG. 3). The inverted j-channel 14 is designed to secure the front section A of the insert 10 to the front of the ice bin unit 30. The inverted j-channel 14 is preferably sized to fit over the upper lip of the front of the ice bin unit 30. Accordingly, when installed, the insert 10 firmly rests within the ice storage cavity of the unit 30 with the front section A being supported on and/or by the front lip of the unit 30. Further, the j-channel 14 allows the front mounting section A to rest securely on the front lip of the unit 30 without having to be physically attached thereto, therefore, the insert 10 can be easily removed for servicing the ice bin unit 30, completing repairs to the ice bin unit 30, servicing a separate loose auxiliary cooling device 40, clearing the unit's drain (not shown), maintaining support connections 42, etc. Alternately, however, the front section A may be attached to the unit 30 with fasteners. The fasteners may be permanent or selectively removable and are preferably mechanical fasteners (e.g., screws, nuts and bolts, rivets, etc.), but they may be otherwise (e.g., an adhesive, welds, etc.). While either may be used, it is to be appreciated that removable fasteners (as compared to permanent ones) provide for easier detachment of the insert 10 from the unit 30 as desired, e.g., for cleaning, servicing, maintenance, etc. of the insert 10, the unit 30, the auxiliary cooling device 40, support connections 42 or other components. In any

Having thus described the preferred embodiments, the invention is now claimed to be:

1. An ice bin insert for a manual service open ice bin having an ice holding cavity, said ice bin insert separating a single store of ice pieces into separate stashes and comprising:
a divider dimension to be received within the ice holding cavity of the ice bin;
support members attached to the divider, said support members holding the divider at a desired position within the ice holding cavity of the ice bin; and,
a plurality of perforations within the divider, said perforations being arranged such that the divider permits ice pieces to flow from a first side thereof to a second side thereof while inhibiting retrieval of ice pieces on the second side from the first side.

2. The ice bin insert of claim 1, wherein said divider and said support members are formed from a substantially rigid material, said support members including at least one wall having a shape which substantially conforms to a contour of an ice bin wall that defines the ice holding cavity of the ice bin.

3. The ice bin insert of claim 2, wherein said divider and said support members are formed from a substantially planar unitary sheet of material having a plurality of bends therein which define the divider and support members.

4. The ice bin insert of claim 1, wherein said divider includes a substantially planar first section.

5. The ice bin insert of claim 4, wherein said support members are arranged to hold the divider at a height above a floor of the ice holding cavity of the ice bin, said height being sufficient to permit an auxiliary cooling device and a layer of ice pieces surrounding the same to be arranged between the divider and the floor of the ice holding cavity of the ice bin.

6. The ice bin insert of claim 5, wherein said support members are arranged to hold the first section substantially parallel to the floor of the ice holding cavity of the ice bin.

7. The ice bin insert of claim 6, wherein said divider includes a substantially planar second section arranged between the first section and at least one of the support members, said second section being sloped relative to the first section.

8. The ice bin insert of claim 4, wherein said support members includes substantially planar first and second walls connected to the divider, each of the first and second walls being connected to respective opposing ends of the divider.

9. The ice bin insert of claim 8, wherein said walls are substantially normal to the first section of the divider.

10. The ice bin insert of claim 8, wherein said walls do not permit ice pieces to flow therethrough.

11. The ice bin insert of claim 8, further comprising:
a channel formed at an end of the first wall opposite the divider, said channel being arranged to receive therein a lip of the ice bin, said lip defining at least a portion of an opening for the ice holding cavity of the ice bin.

12. The ice bin insert of claim 8, further comprising:
a substantially planar connecting plate formed at an end of the second wall opposite the divider, said connecting plate being arranged for engagement with at least a portion of the ice bin so that the insert is supported therefrom.

13. The ice bin insert of claim 12, wherein said connecting plate is substantially normal to the second wall and arranged so as to rest upon a portion of the ice bin.

14. The ice bin insert of claim 13, wherein said connecting plate includes at least one opening therein for passing through connections to an auxiliary cooling device situated under the insert in the ice holding cavity of the ice bin.

15. The ice bin insert of claim 13, wherein said connecting plate includes holes therein through which fasteners pass to fasten the insert to the ice bin.

16. An insert for an ice bin, said insert comprising:
a vertically extending first wall, said first wall being solid and having opposing first and second ends;
a vertically extending second wall, said second wall being solid and having opposing first and second ends; and,
a horizontally extending perforated first plate connected between the first ends of the first and second walls;
wherein said insert is arranged so as to permit ice pieces to migrate through the first plate and restrict access to ice pieces once they have migrated through the first plate.

17. The insert of claim 16, further comprising:
a perforated second plate connected between the first plate and the second wall, said second plate being sloped with respect to the first plate and permitting ice pieces to migrate therethrough.

18. The insert of claim 17, further comprising:
a channel formed at the second end of the first wall, said channel arranged to receive at least a portion of a lip of an ice bin such that the insert is supported thereon.

19. The insert of claim 17, further comprising:
a connection plate formed at the second end of the second wall, said connection plate arranged to engage with at least a portion of an ice bin such that the insert is supported thereby.

20. The insert of claim 17, wherein the first and second walls and the first and second plates are formed from a unitary sheet of stainless steel.

21. The insert of claim 16, wherein a portion of the insert rests upon a portion of the ice bin without being attached thereto such that the insert is supported by the ice bin and selectively removable from and installable in the ice bin, said first plate being positioned inside an ice holding cavity of the ice bin above a floor of the ice holding cavity when the insert is installed in the ice bin.

22. A beverage cooling system comprising:
an ice bin having an ice holding cavity including a floor and one or more walls defining the cavity and an opening through which ice pieces are selective loaded into and removed from the cavity;
a loose auxiliary cooling device separate from the ice bin and placed on the floor inside the cavity of the ice bin;
one or more supporting connections operatively connected with the cooling device to circulate a beverage to be cooled through the cooling device;
a divider arranged within the ice holding cavity of the ice bin;
support members attached to the divider, said support members holding the divider at a desired position above the cooling device within the ice holding cavity of the ice bin; and,
a plurality of perforations within the divider, said perforations being arranged such that the divider permits ice pieces to flow from a top side of the divider to a bottom side of the divider while inhibiting retrieval of ice pieces on the bottom side from the top side.

23. The beverage cooling system of claim 22, wherein the divider and support members comprise an insert which is selectively removable from the ice bin.

24. The beverage cooling system of claim 23, wherein the insert includes cutouts through which the supporting connections are routed when the insert is installed in the ice bin

25. The beverage cooling system of claim 23, wherein the insert extends through the opening of the ice bin when installed therein.
